(19) United States
(12) Patent Application Publication
(10) Pub. No.: US 2018/0318042 A1
(43) Pub. Date: Nov. 8, 2018

(54) ORTHODONTIC BRACES

(71) Applicants: Jae Ho BAEK, Busan (KR); FES CO., LTD., Ulsan (KR)

(72) Inventor: Jae Ho BAEK, Busan (KR)

(73) Assignees: FES CO., LTD., Ulsan (KR); Jae Ho BAEK, Busan (KR)

(21) Appl. No.: 15/775,397

(22) PCT Filed: Nov. 11, 2016
(86) PCT No.: PCT/KR2016/012995

§ 371 Date: Jul. 2, 2018

(30) Foreign Application Priority Data
Nov. 11, 2015 (KR) 10-2015-0158296

(51) Int. Cl. A61C 7/08

(52) U.S. Cl. CPC A61C 7/08

(57) ABSTRACT

Orthodontic braces include: a correction frame provided to cover a corresponding group of teeth by having, on an inner surface, a correction recess corresponding to a correct tooth form of teeth, and formed of a soft or hard material; and a support frame tightly coupled to surround an outer surface of the correction frame, and formed of soft or hard material, wherein a coupling groove portion is formed at an edge end portion of an outer surface of the correction frame, and a coupling bent portion correspondingly engaged and coupled to the coupling groove portion is formed at an edge end portion of an inner surface of the support frame.

### TECHNICAL FIELD

The present disclosure relates to orthodontic braces for gradually moving and correcting teeth by using a frame.

### BACKGROUND ART

In general, orthodontics is widely practiced for plastic surgery or treatment of malocclusion. Conventionally, a fixed orthodontic device, i.e., a device that corrects teeth by adhesively fixing brackets to the teeth and then attaching a wire to the brackets to pull or push the wire, has been widely used. Here, with respect to the fixed orthodontic device, the brackets are generally provided on smooth outer surfaces of the teeth, i.e., labially. Such a fixed orthodontic device is advantageous in terms of effects and convenience of procedures, but is often avoided by patients due to bad aesthetic looks.

In order to solve aesthetic problems of such a fixed orthodontic device and inconvenience that the patients should always wear the fixed orthodontic device, transparent orthodontic devices (or procedure), such as an Invisalign and a clear-aligner, have been suggested. The Invisalign and the clear-aligner are both transparent orthodontic devices and are worn like a mouse piece.

However, conventional transparent orthodontic devices depend on elastic restoring force generated when elastic deformation occurs, and thus have relatively low orthodontic force. In this regard, the transparent orthodontic devices have increased thicknesses or are manufactured by using a hard material, but cause gingival irritation or tooth pain.

Such a conventional transparent orthodontic device (transparent aligner) is disclosed in KR 10-1463423 (published on Nov. 13, 2014).

### DESCRIPTION OF EMBODIMENTS

### Technical Problem

Provided are orthodontic braces having excellent orthodontic force and capable of suppressing pain during orthodontics.

### Solution to Problem

According to an aspect of the present disclosure, orthodontic braces include: a correction frame provided to cover a corresponding group of teeth by having, on an inner surface, a correction recess corresponding to a correct tooth form of teeth, and formed of a soft or hard material; and a support frame tightly coupled to surround an outer surface of the correction frame, and formed of soft or hard material, wherein a coupling groove portion is formed at an edge end portion of an outer surface of the correction frame, and a coupling bent portion correspondingly engaged and coupled to the coupling groove portion is formed at an edge end portion of an inner surface of the support frame.

The support frame may be formed of a hard material when the correction frame is formed of a soft material, and the support frame may be formed of a soft material when the correction frame is formed of a hard material.

A plurality of engaging grooves penetrating through the correction frame may be formed at the correction frame, and an engaging protrusion correspondingly coupled to the plurality of engaging grooves may be formed on an inner surface of the support frame.

Each of the plurality of engaging grooves may have a structure in which a diameter increases from an outer surface to an inner surface of the correction frame.

The orthodontic braces may further include a coupling clip coupled to an outer surface of the correction frame to increase a coupling force with the support frame.

A coupling protrusion may be formed on the outer surface of the correction frame, a protrusion insertion groove may be formed on an inner surface of the support frame, and the coupling clip may include: a clip body having an uneven one side surface portion facing the outer surface of the correction frame, and a through hole correspondingly coupled to the coupling protrusion; and a protruding portion extending from the other side surface portion of the clip body to the support frame, and inserted to the protrusion insertion groove of the support frame.

A separation clip having a vertical cross-sectional shape of ‘u’ formed by bending two ends may be further provided between the correction frame and the support frame.

The separation clip may be formed of a metal material, and a surface portion of the separation clip facing an inner surface of the support frame may be uneven.

The support frame may be coupled via compression while being heated, while provided on an outer surface of the correction frame.

### Advantageous Effects of Disclosure

In orthodontic braces according to the present disclosure, a correction frame is provided to cover a corresponding group of teeth while having a correction recess corresponding to a correct tooth form of the teeth, and a support frame is combined to an external surface of the correction frame, and thus pain is suppressed during orthodontics by the correction frame formed of a soft material while orthodontic force by the support frame formed of a hard material is maintained. Also, stable orthodontic force is maintained with respect to the group of teeth by maintaining a stable coupling state as a coupling groove portion and a coupling bent portion, which are coupled to each other, are formed respectively at edge end portions of the correction frame and the support frame.

### BRIEF DESCRIPTION OF DRAWINGS

FIG. 1 is a perspective view of orthodontic braces according to an embodiment of the present disclosure.

FIG. 2 is a plan view of FIG. 1.

FIG. 3 is a cross-sectional view taken along a line III-III of FIG. 1.

FIG. 4 is a partial configuration cross-sectional view of orthodontic braces according to another embodiment of the present disclosure.

FIG. 5 is a partial configuration cross-sectional view of orthodontic braces according to another embodiment of the present disclosure.

FIG. 6 is a configuration plan view of orthodontic braces according to another embodiment of the present disclosure.

FIG. 7 is a cross-sectional view taken along a line VII-VII of FIG. 6.

### BEST MODE

Hereinafter, exemplary embodiments of the present disclosure will be described in detail with reference to accompanying drawings.

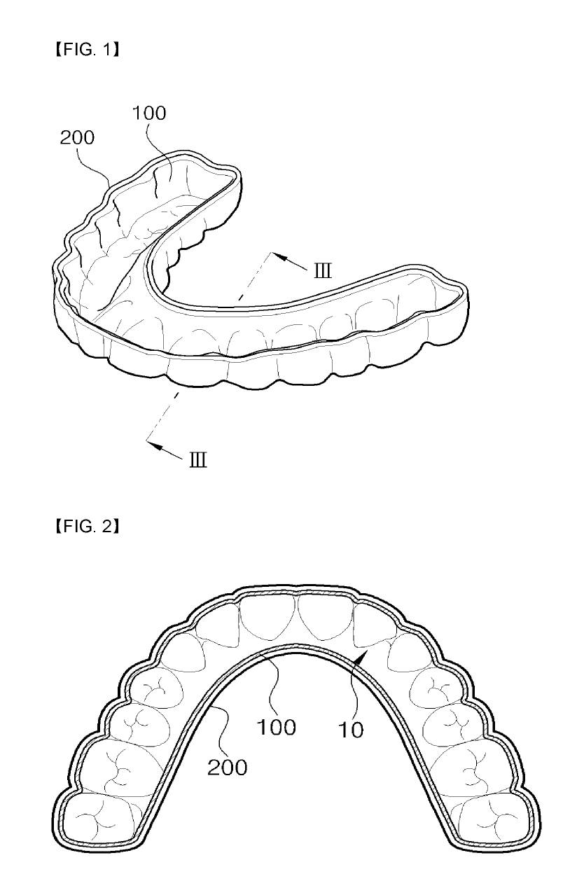

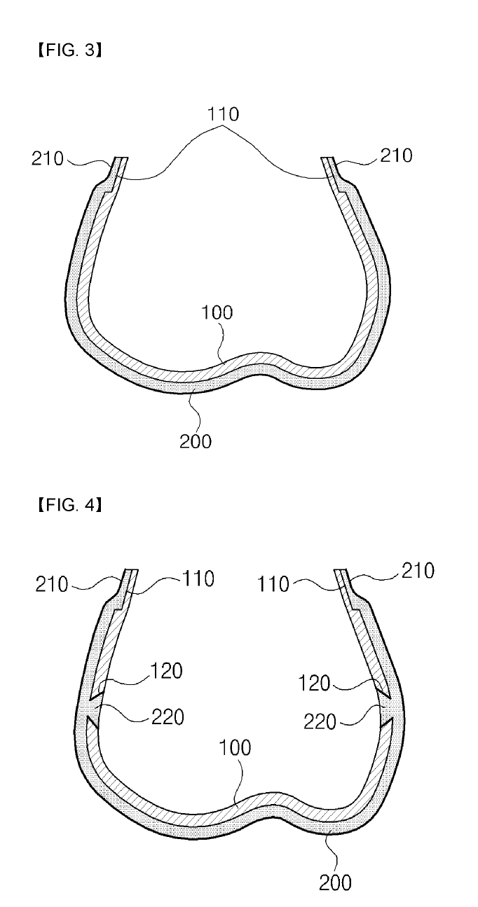

FIG. 1 is a perspective view of orthodontic braces according to an embodiment of the present disclosure, FIG. 2 is a plan view of FIG. 1, and FIG. 3 is a cross-sectional view taken along a line III-III of FIG. 1. Referring to FIGS. 1 through 3, the orthodontic braces include a correction frame 100 and a support frame 200.

The correction frame 100 is a frame directly contacting teeth while provided at the teeth. In other words, a correction recess 101 corresponding to a correct tooth form of the teeth is provided on an inner surface of the correction frame 100, in detail, a surface portion facing the teeth, to cover a corresponding group of teeth. Here, the correction frame 100 may be formed of a soft synthetic resin having elasticity so as to suppress pain from occurring in a user while the correction frame 100 is provided to cover the group of teeth, but alternatively, may be formed of a hard synthetic resin having elasticity. Here, the correction frame 100 may have a transparent color for excellent aesthetics, but alternatively, may have an opaque color.

The correction recess 101 having a shape corresponding to the correct tooth form of the teeth may be formed on the inner surface of the correction frame 100 by placing a soft synthetic resin sheet on a mold (not shown) having a shape of teeth to be corrected, and then compressing the soft synthetic resin sheet while heating.

Then, a coupling groove portion 110 is formed around an edge end portion of an outer surface of the correction frame 100. Such a coupling groove portion 110 decreases a thickness of the edge end portion of the outer surface of the correction frame 100 to be thinner than a thickness of a remaining portion of the outer surface of the correction frame 100 excluding the edge end portion of the outer surface of the correction frame 100, such that when the support frame 200 described later is compressed and coupled to the outer surface of the correction frame 100 while being heated, a stable coupling state is maintained as an edge end portion of the support frame 200 is engaged to the coupling groove portion 110. In addition, the coupling groove portion 110 decreases the thickness of the edge end portion of the outer surface of the correction frame 100 to be thinner than the thickness of the remaining portion of the outer surface of the correction frame 100 excluding the edge end portion of the outer surface of the correction frame 100, such that when the support frame 200 is coupled to the outer surface of the correction frame 100, elastic pressure at the edge end portion of the correction frame 100 by the support frame 200 is increased, thereby preventing the correction frame 100 from being easily detached while provided on the teeth.

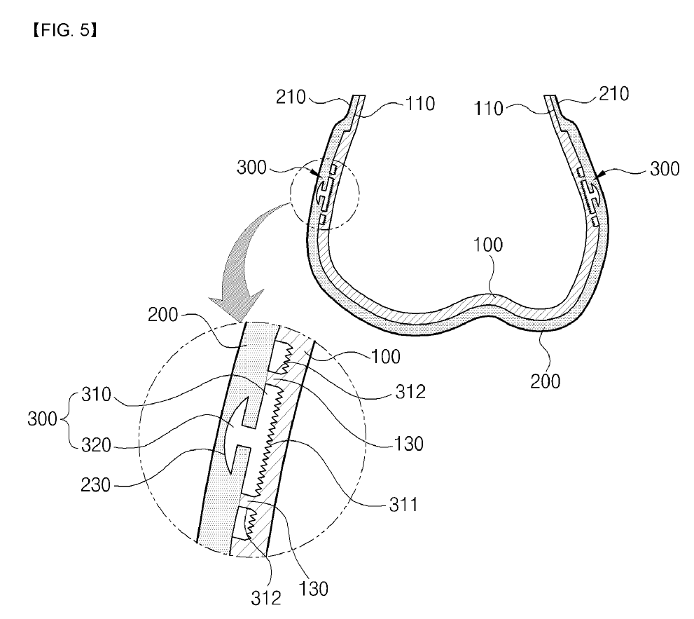

Referring to FIG. 4, a plurality of engaging grooves 120 may be formed on the correction frame 100. Such engaging grooves 120 penetrate through the correction frame 100 such that when the support frame 200 described later is compressed and coupled to the outer surface of the correction frame 100 while being heated, a stable coupling state is maintained between the correction frame 100 and the support frame 200 as an inner surface portion of the support frame 200 corresponding to the engaging groove 120 is inserted and coupled in a molten state.

Here, the engaging groove 120 has a structure in which a diameter increases from the outer surface to the inner surface of the correction frame 100, and thus a stable engaging and coupling state is maintained without detachment when the corresponding inner surface portion of the support frame 200 is inserted and coupled to the engaging groove 120 in the molten state.

Referring to FIG. 5, a coupling clip 300 increasing a coupling force when the support frame 200 described later is pressurized and coupled while being heated may be coupled to the outer surface of the correction frame. Such a coupling clip 300 includes a clip body 310 and a protruding portion 320.

Here, the clip body 310 is a plate portion coupled to the outer surface of the correction frame 100. An uneven portion 311 is formed on one side surface portion of the clip body 310, i.e., on a surface portion facing the outer surface of the correct frame 100, such that a contact surface with the correction frame 100 is increased for stable coupling. Also, a plurality of through holes 312 may be formed at one side of the clip body 310. Here, the through hole 312 maintains a stable coupling state of the clip body 310 to the outer surface of the correction frame 100 as a coupling protrusion 130 protruding on the outer surface of the correction frame 100 is correspondingly inserted and coupled to the through hole 312. Here, the coupling protrusion 130 is formed as a corresponding outer surface portion of the correction frame 100 is melted and passed through the through hole 312 when the support frame 200 is compressed and coupled to the outer surface of the correction frame 100 while being heated, and at this time, an end portion of the coupling protrusion 130 may be connected to the inner surface of the support frame 200.

Also, the protruding portion 320 continuously formed to extend from the other side surface portion of the clip body 310, i.e., a surface portion facing the support frame 200 described later, to the support frame 200. Here, the protruding portion 320 may be inserted and coupled correspondingly to a protrusion insertion groove 230 formed at a corresponding location of the support frame 200. In addition, when the protrusion insertion groove 230 is not formed on the inner surface of the support frame 200, the protruding portion 320 may be engaged and coupled while being forcibly inserted thereinto through the inside of the melted support frame 200 when the support frame 200 is compressed and coupled to the outer surface of the correction frame 100 while being heated.

The support frame 200 maintains an orthodontic force of the teeth by the correction frame 100 while being coupled to the correction frame 100. In other words, an inner surface portion of the support frame 200, i.e., a surface portion facing the outside of the correction frame 100, is formed to have a shape corresponding to the outer surface of the correction frame 100, such as to be tightly coupled to surround the outside of the correction frame 100. Here, a coupling bent portion 210 having a bent shape to correspond to a shape of the coupling groove portion 110 of the correction frame 100 is provided at an edge end portion of an inner surface of the support frame 200, i.e., an edge end portion of a surface portion facing the outside the correction frame 100. Such a coupling bent portion 210 is correspondingly inserted and engaged to the coupling groove portion 110 to maintain a stable fixing and coupling state while the support frame 200 is closely arranged on the outer surface of the correction frame 100. Here, the support frame 200 may be formed of a hard synthetic resin having elasticity such that a shape of the correction frame 100 is maintained while being closely coupled to the outer surface of the correction frame 100, but alternatively, may be formed of a soft synthetic resin having elasticity. Here, the support frame 200 may be formed of a transparent color for excellent aesthetics, but alternatively, may be formed of an opaque color.

According to such a support frame 200, while the correction frame 100 is formed by placing a soft synthetic resin sheet on a mold having a shape of teeth to be corrected and then compressing the soft synthetic resin sheet while being heated as described above, a hard synthetic resin sheet may be placed on the correction frame 100, i.e., on the outer surface of the correction frame 100, and then compressed while being heated such that the inner surface of the support frame 200 and the outer surface of the correction frame 100, which face each other, are coupled in a molten state. Here, the edge end portion of the support frame 200 is formed to be the coupling bent portion 210 to be correspondingly inserted and engaged to the coupling groove portion 110 of the correction frame 100, such that the coupling with the correction frame 100 is stably maintained.

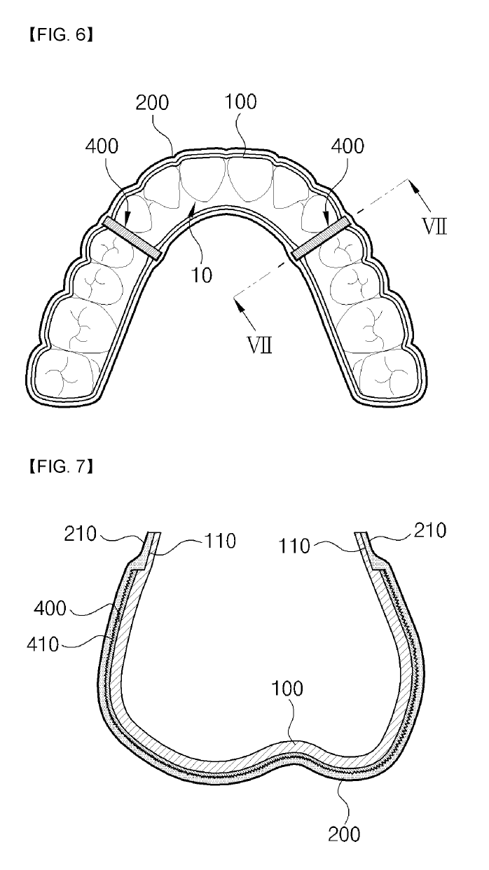

Referring to FIGS. 6 and 7, a plurality of separation clips 400 may be provided between the correction frame 100 and the support frame 200. Such a separation clip 400 prevents a cutter (not shown) from reaching the correction frame 100 when a portion of the support frame 200 is to be cut and removed by the cutter, and thus only the portion of the support frame 200 to be removed is stably cut and removed. Here, the separation clip 400 is formed to have a vertical cross-sectional shape of ‘u’ formed by bending two ends so as to be closely provided between the outer surface of the correction frame 100 and the inner surface of the support frame 200. Here, an uneven portion 410 may be formed on one side surface portion of the separation clip 400, i.e., a surface portion facing the inner surface of the support frame 200. Such an uneven portion 410 formed on the separation clip 400 enables an end portion of the cutter to pass through the inner surface of the support frame 200 for easy cutting, when the support frame 200 is cut by the cutter. Here, the support frame 200 may be formed of a metal material so as not to be damaged when contacting the cutter, but a material is not limited thereto.

Here, the thickness of the correction frame 100 may be formed to be thicker than the thickness of the support frame 200, and thus a stable orthodontic force the teeth is maintained through the correction frame 100 even when a portion of the support frame 200 is removed using the separation clip 400 described above.

As such, in the orthodontic braces according to an embodiment, the correction frame 100 is provided to cover a corresponding group of teeth 10 while having the correction recess corresponding to the correct tooth form of the teeth, and the support frame 200 is combined to the external surface of the correction frame 100, and thus pain is suppressed during orthodontics by the correction frame 100 formed of the soft material while orthodontic force by the support frame 200 formed of the hard material is maintained. Also, stable orthodontic force is maintained with respect to the group of teeth 10 by maintaining a stable coupling state as the coupling groove portion 110 and the coupling bent portion 210, which are coupled to each other, are formed respectively at the edge end portions of the correction frame 100 and the support frame 200.

Here, when an open bite in which only the posterior teeth of the upper and lower teeth are touched while the anterior teeth are not touched is treated, the correction frame 100 described above may be formed of a hard synthetic resin having elasticity and the support frame 200 may be formed of a soft synthetic resin having elasticity so as to rotate a raised molar tooth from the upper and lower teeth back to a state of being surrounded by a normal gum bone. As such, by forming the correction frame 100 of a hard material, fidelity with the group of teeth 10 is increased, and the support frame 200 formed of a soft material may effectively rotate the raised molar tooth on the opposite side to be surrounded by the normal gum bone by using elasticity of the soft material.

An orthodontic method using the orthodontic braces described above will now be described. First, the orthodontic braces described above are prepared. Here, a patient having the group of teeth 10 to be corrected may have a tooth at a required position extracted when necessary for orthodontics.

Then, the correction frame 100 of the orthodontic braces is provided to cover the group of teeth 10 of the patient. Then, the correction frame 100 and the support frame 200 recover a shape of the alveolar bone around the distorted tooth of the patient. In other words, the correction frame 100 and the support frame 200 continuously apply the orthodontic force to the group of teeth 10, and at this time, the soft correction frame 100 applies the orthodontic force to such an extent that the alveolar bone and the dental root are not damaged. As such, the soft correction frame 100 generates a weak orthodontic force applied to the group of teeth of the patient, and the hard support frame 200 prevents deformation of the correction frame 100 such that the orthodontic force is continuously generated.

As such, while the orthodontic braces are provided to correct the teeth of the patient, a portion of the support frame 200 of the orthodontic braces is removed correspondingly to a portion where the tooth of the patient is extracted. In other words, the portion of the support frame 200 located above the pair of separation clips 400 adjacent to the portion where the tooth is extracted is cut by using the cutter to remove the portion of the support frame 200. A portion of the correction frame 100 corresponding to the removed portion of the support frame 200 is contracted, thereby gradually closing the portion where the tooth is extracted. Here, when the teeth are inclined due to a force generated when the portion where the tooth is extracted is closed, the remaining support frame 200 excluding the removed portion enables masticatory force of the patient to be applied in a distributed state, and thus the axis of the teeth may be restored to be approximately perpendicular to the occlusal surface without unnecessary generation of frictional force. As such, the orthodontic force may be changed by removing the portion of the support frame 200 according to an orthodontic portion of the patient, and thus the orthodontics may be performed using one piece of orthodontic braces without having to use additional orthodontic braces.

As such, after movement of the teeth is completed, the soft correction frame 100 enables painless orthodontics to be performed by transferring force having reinforced elasticity while deformation of force at a portion where the teeth and the alveolar bone of the patient contact is minimized.

As such, in the orthodontic braces according to an embodiment, the orthodontic braces in which the hard support frame 200 is coupled to surround the outer surface of the soft correction frame 100 is provided to surround the group of teeth of the patient, and thus a weak orthodontic force applied to the group of teeth of the patient is generated to prevent pain, while continuous orthodontic force is maintained. Accordingly, stable orthodontics may be performed using only one piece of orthodontic braces.

While the present disclosure has been particularly shown and described with reference to exemplary embodiments thereof, it will be understood by those of ordinary skill in the art that various changes in form and details may be made therein without departing from the spirit and scope of the present disclosure as defined by the following claims.

1. Orthodontic braces comprising:
a correction frame provided to cover a corresponding group of teeth by having, on an inner surface, a correction recess corresponding to a correct tooth form of teeth, and formed of a soft or hard material; and
a support frame tightly coupled to surround an outer surface of the correction frame, and formed of soft or hard material,
wherein a coupling groove portion is formed at an edge end portion of an outer surface of the correction frame, and
a coupling bent portion correspondingly engaged and coupled to the coupling groove portion is formed at an edge end portion of an inner surface of the support frame.

2. The orthodontic braces of claim 1, wherein the support frame is formed of a hard material when the correction frame is formed of a soft material, and
the support frame is formed of a soft material when the correction frame is formed of a hard material.

3. The orthodontic braces of claim 1, wherein a plurality of engaging grooves penetrating through the correction frame is formed at the correction frame, and
an engaging protrusion correspondingly coupled to the plurality of engaging grooves is formed on an inner surface of the support frame.

4. The orthodontic braces of claim 3, wherein each of the plurality of engaging grooves has a structure in which a diameter increases from an outer surface to an inner surface of the correction frame.

5. The orthodontic braces of claim 1, further comprising a coupling clip coupled to an outer surface of the correction frame to increase a coupling force with the support frame.

6. The orthodontic braces of claim 5, wherein a coupling protrusion is formed on the outer surface of the correction frame,
a protrusion insertion groove is formed on an inner surface of the support frame, and
the coupling clip comprises:
a clip body having an uneven one side surface portion facing the outer surface of the correction frame, and a through hole correspondingly coupled to the coupling protrusion; and
a protruding portion extending from the other side surface portion of the clip body to the support frame, and inserted to the protrusion insertion groove of the support frame.

7. The orthodontic braces of claim 1, wherein a separation clip having a vertical cross-sectional shape of ‘u’ formed by bending two ends is further provided between the correction frame and the support frame.

8. The orthodontic braces of claim 7, wherein the separation clip is formed of a metal material, and
a surface portion of the separation clip facing an inner surface of the support frame is uneven.

9. The orthodontic braces of claim 1, wherein the support frame is coupled via compression while being heated, while provided on an outer surface of the correction frame.
